(19) United States
(12) Patent Application Publication
(10) Pub. No.: US 2019/0108280 A1
(43) Pub. Date: Apr. 11, 2019

(54) IMAGE SEARCH AND INDEX BUILDING

(71) Applicant: Alibaba Group Holding Limited, Grand Cayman (KY)

(72) Inventors: Ruitao Liu, Hangzhou (CN); Yu Liu, Hangzhou (CN)

(73) Assignee: Alibaba Group Holding Limited

(21) Appl. No.: 16/156,931

(22) Filed: Oct. 10, 2018

(30) Foreign Application Priority Data
Oct. 10, 2017 (CN) 201710935506.5

(51) Int. Cl. G06F 17/30

(52) U.S. Cl. CPC G06F 17/30864; G06F 17/30256; G06F 17/30271

(57) ABSTRACT

A method including receiving a query request carrying a keyword; generating a search vector that represents the keyword; and selecting, in a same vector space, an image vector matching the search vector to obtain a result set. The technical solutions of the present disclosure improve the accuracy of a search result during image search.

### CROSS REFERENCE TO RELATED PATENT APPLICATIONS

This application claims priority to and is a continuation of Chinese Patent Application No. 201710935506.5 filed on 10 Oct. 2017 and entitled “IMAGE SEARCH METHOD AND SYSTEM, AND INDEX BUILDING METHOD AND MEDIUM,” which is incorporated herein by reference in its entirety.

### TECHNICAL FIELD

This present application relates to the field of computer technologies, and, more particularly, to image search methods and systems, and index building methods and media.

### BACKGROUND

Computer technologies are increasingly popularized as society develops. People browse various pages through the Internet to meet different requirements.

In some cases, a user will browse images by using an electronic device. For ease of browsing, the user may input a keyword for query.

### SUMMARY

This Summary is provided to introduce a selection of concepts in a simplified form that are further described below in the Detailed Description. This Summary is not intended to identify all key features or essential features of the claimed subject matter, nor is it intended to be used alone as an aid in determining the scope of the claimed subject matter. The term “technique(s) or technical solution(s)” for instance, may refer to apparatus(s), system(s), method(s) and/or computer-readable instructions as permitted by the context above and throughout the present disclosure.

The example embodiments of the present disclosure provide image search methods and systems, and index building methods and media.

The example embodiments of the present disclosure provide an image search method, including: receiving a query request carrying a keyword; generating a search vector according to the query request, wherein the search vector is used to represent the keyword; and selecting, in the same vector space, an image vector matching the search vector to obtain a result set, the image vector being used to represent an image and a text of the image.

The example embodiments of the present disclosure provide an image search system, including: a request receiving module configured to receive a query request carrying a keyword; a search vector generation module configured to generate a search vector according to the query request, wherein the search vector is used to represent the keyword; and a query module configured to select, in the same vector space, an image vector matching the search vector to obtain a result set, the image vector being used to represent an image and a text of the image.

The example embodiments of the present disclosure provide an image search system, including: a service server and a search engine. The service server is configured to receive a query request carrying a keyword and provided by a client terminal; generate, according to the query request, a search vector capable of representing the keyword, and provide the search vector to the search engine; and feed an obtained result set back to the client terminal. The search engine is configured to select, in the same vector space, an image vector matching the search vector to obtain a result set; and feed the result set back to the service server, wherein the image vector is used to represent an image and a text of the image.

The example embodiments of the present disclosure provide an index building method, including: acquiring an image and a text corresponding to the image; generating an image vector according to the image and the text, the image vector being used to represent the image and the text; and building an index according to the image vector and an access identifier of the image, wherein the access identifier is used to acquire the corresponding image.

The example embodiments of the present disclosure provide an image management system, including: an image acquiring module configured to acquire an image and a text corresponding to the image; an image vector generation module 212 configured to generate an image vector according to the image and the text, the image vector being used to represent the image and the text; and an index building module configured to build an index according to the image vector and an access identifier of the image, wherein the access identifier is used to acquire the corresponding image.

The example embodiments of the present disclosure provide one or more computer storage media, wherein the computer storage medium stores computer-readable instructions, and when being executed by one or more processors, cause the processor to perform the following acts: acquiring an image and a text corresponding to the image; generating an image vector according to the image and the text, the image vector being used to represent the image and the text; and building an index according to the image vector and an access identifier of the image, wherein the access identifier is used to acquire the corresponding image.

The example embodiments of the present disclosure provide an image search method, including: sending a query request to a server, wherein the query request carries a keyword, such that the server generates a search vector according to the query request, and selects, in the same vector space, an image vector matching the search vector to obtain a result set, wherein the image vector is used to represent an image and a text of the image; and receiving the result set fed back by the server.

The example embodiments of the present disclosure provide an image search method, including: receiving a query request; generating a search vector according to the query request; and selecting an image vector matching the search vector to obtain a result set, the image vector being used to represent an image and a text of the image.

As shown from the technical solutions provided in the example embodiments of the present disclosure that, by adopting an image vector that represents an image and a text of the image, the accuracy of an image obtained by query is improved when a matching operation between a search vector of a keyword and the image vector is performed. Therefore, the image search method provides accurate search results and better experiences for users.

### BRIEF DESCRIPTION OF THE DRAWINGS

To describe the technical solutions in the example embodiments of the present disclosure more clearly, the drawings used in the example embodiments are briefly introduced. The drawings in the following description merely represent some example embodiments of the present disclosure, and those of ordinary skill in the art may further obtain other drawings according to these drawings without creative efforts.

FIG. 1 is a schematic modular diagram of an image search system according to an example embodiment of the present disclosure;

FIG. 2 is a schematic modular diagram of an image management system according to an example embodiment of the present disclosure;

FIG. 3 is a flowchart of a method for optimizing an image search process according to an example embodiment of the present disclosure;

FIG. 4 is a schematic interaction diagram of an image search system according to an example embodiment of the present disclosure;

FIG. 5 is a schematic diagram of a relationship between vectors according to an example embodiment of the present disclosure;

FIG. 6 is a flowchart of an image search method according to an example embodiment of the present disclosure;

FIG. 7 is a flowchart of an image search method according to an example embodiment of the present disclosure;

FIG. 8 is a flowchart of an image search method according to an example embodiment of the present disclosure;

FIG. 9 is a schematic diagram of an image search interface according to an example embodiment of the present disclosure;

FIG. 10 is a schematic diagram of an image search interface according to an example embodiment of the present disclosure;

FIG. 11 is a flowchart of an image search method according to an example embodiment of the present disclosure;

FIG. 12 is a flowchart of an image search method according to an example embodiment of the present disclosure;

FIG. 13 is a schematic diagram of an image search interface according to an example embodiment of the present disclosure;

FIG. 14a is a schematic diagram of an image and a text according to an example embodiment of the present disclosure;

FIG. 14b is a schematic diagram of an image and a text according to an example embodiment of the present disclosure;

FIG. 14c is a schematic diagram of an image and a text according to an example embodiment of the present disclosure;

FIG. 14d is a schematic diagram of an image and a text according to an example embodiment of the present disclosure; and

FIG. 15 is a schematic diagram of an image search interface according to an example embodiment of the present disclosure.

### DETAILED DESCRIPTION

In order to enable those skilled in the art to better understand the technical solutions in the present disclosure, the technical solutions in the example embodiments of the present disclosure are described below with reference to the accompanying drawings in the example embodiments in the present disclosure. Apparently, the described example embodiments merely represent some, rather than all, of the example embodiments of the present disclosure. Based on the example embodiments in the present disclosure, all other example embodiments obtained by those of ordinary skill in the art without creative efforts should belong to the protection scope of the present disclosure.

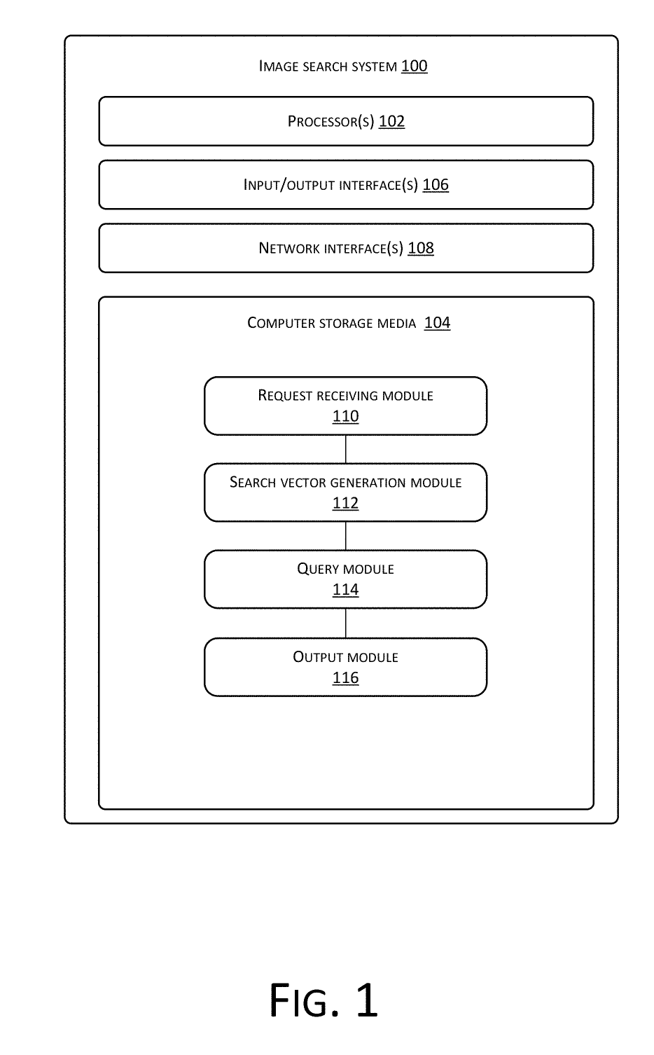

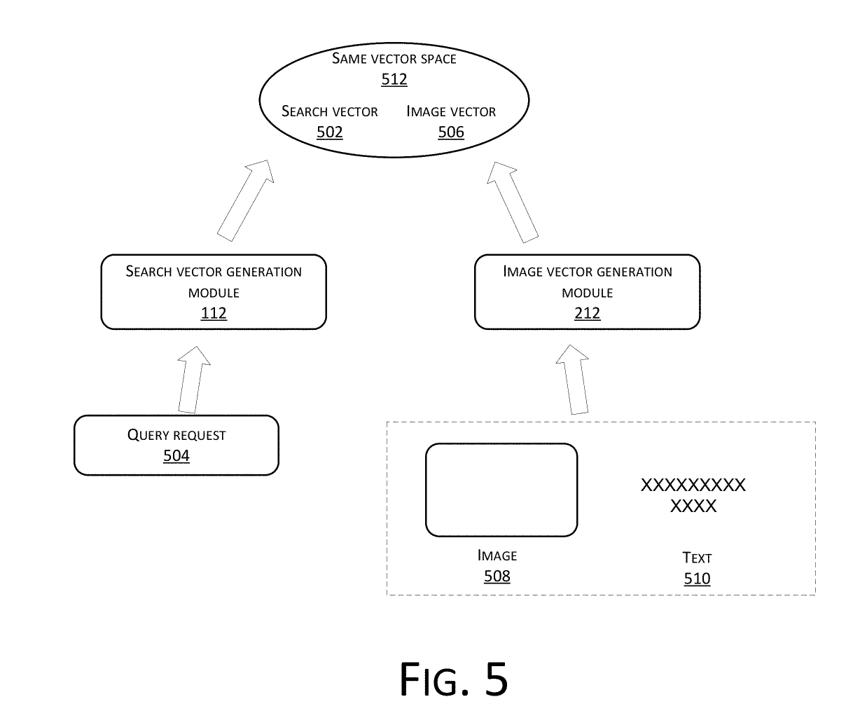

Referring to FIG. 1 and FIG. 5, the example embodiments of the present disclosure provide an image search system 100. The image search system 100 includes one or more processor(s) 102 or data processing unit(s) and computer storage media 104. The image search system 100 may further include one or more input/output interface(s) 106 and one or more network interface(s) 108.

The computer storage media include non-volatile and volatile media as well as movable and non-movable media, and may implement information storage by means of any method or technology. Information may be a computer readable instruction, a data structure, and a module of a program or other data. A storage medium of a computer includes, for example, but is not limited to, a phase change memory (PRAM), a static random access memory (SRAM), a dynamic random access memory (DRAM), other types of RAMs, a ROM, an electrically erasable programmable read-only memory (EEPROM), a flash memory or other memory technologies, a compact disk read-only memory (CD-ROM), a digital versatile disc (DVD) or other optical storages, a cassette tape, a magnetic tape/magnetic disk storage or other magnetic storage devices, or any other non-transmission medium, and may be used to store information accessible to the computing device. According to the definition of this text, the computer storage medium or media do not include transitory media, such as a modulated data signal and a carrier.

The computer storage media 104 may store therein a plurality of modules or units including a request receiving module 110, a search vector generation module 112, a query module 114, and an output module 116.

The request receiving module 110 is configured to receive a query request. The query request may carry a keyword. The request receiving module 110 receives the query request, which requests to provide an image related to the keyword or provide information for acquiring an image to a client terminal sending the query request. The request receiving module 110 may receive the query request based on a network communication protocol. For example, the network communication protocol includes, but is not limited to, HTTP, TCP/IP, and the like.

In this example embodiment, the keyword may be information inputted on a client terminal by a user, so as to search for an image that the user intends to browse. The keyword itself may be a character string having certain semantic meaning. For example, when the user intends to purchase a luggage, the user may input a keyword “luggage” on the client terminal. The user may have a more specific requirement. For example, the user may intend to purchase a business luggage. In this case, a keyword inputted by the user may be “business luggage”.

The search vector generation module 112 may generate a search vector according to the query request. The search vector may be used to perform a matching operation in the query module 114. The search vector generation module may generate a search vector based on the entire query request or generate a search vector based on the keyword carried by the query request.

In this example embodiment, the search vector generated by the search vector generation module 112 is located in a designated vector space. As such, by designating a vector space of the search vector, the search vector generated according to the query request and an image vector in the query module 114 may have the same vector space, such that a matching operation may be performed on the search vector and the image vector. Certainly, it is also possible that the search vector generation module 112 generates a search vector and then maps the search vector to a designated vector space. Similarly, the image vector may be located in a designated vector space when the image vector is generated, or the image vector may be mapped to a designated vector space after the image vector is generated. As such, it is implemented that the search vector and the image vector are located in the same vector space.

In this example embodiment, the search vector generation module 112 may generate the search vector according to a deep learning algorithm. The deep learning algorithm may be a neural network algorithm. For example, the deep learning algorithm may use Recurrent Neural Networks (RNN), Long Short-Term Memory (LSTM), and the like. Certainly, the algorithm implementing the search vector generation module 112 is not limited to the algorithms listed in the foregoing. Those skilled in the art may further make other changes or selections in the light of the technical essence of the present application. The changes or selections should all be encompassed in the protection scope of the present application as long as functions and effects implemented by the changes or selections are identical or similar to those of the present disclosure.

The query module 114 may select, in the same vector space, an image vector matching the search vector to obtain a result set. For example, the query module 114 performs a matching operation on the search vector in an index to obtain an image vector matching the search vector. Then, an image that needs to be fed back to the client terminal may be determined according to a corresponding relationship between the image vector and the image. The index may include the image vector and an access identifier of the image represented by the image vector. The matching operation may be performed on the search vector and the image vector, so as to determine whether the image represented by the image vector meets description of the keyword. The access identifier may represent an access address of the image, or the image may be determined according to the access identifier. After performing the matching operation, the query module 114 may output a result set that includes the access identifier corresponding to the image vector matching the search vector. For example, the access identifier may be a Uniform Resource Locator (URL) of the image. As such, in a Content Delivery Network (CDN), the client terminal may receive the URL of the image, and then access the URL to acquire the image.

It may be understood that the result set may merely include the image vector. As such, after the image vector is provided to the client terminal, the client terminal may further acquire the access identifier of the image according to the image vector, or directly obtain the access address such as a URL of the image, so as to obtain the image.

In this example embodiment, an image vector matching the search vector is selected in the same vector space. It is possible that the search vector and the image vector are already located in the same vector space when they are generated. It is also possible that after the search vector and the image vector are generated, one of them is transferred to a vector space of the other, such that they are located in the same vector space. It is also possible that after the search vector and the image vector are generated, they are both transferred to the same vector space. In this example embodiment, the search vector and the image vector are located in the same vector space, such that a matching operation may be performed on the search vector and the image vector.

In this example embodiment, the image vector may represent an image and a text of the image. As such, the image vector may represent the image comprehensively. As a result, when matching is performed between the search vector and the image vector, the following functions may be implemented: when content presented by the image meets content of the keyword, it may be concluded that the image vector and the search vector meet a designated relationship; when the text of the image meets the content of the keyword, it may be concluded that the image vector and the search vector meet a designated relationship; when the image and the text of the image both meet the content of the keyword, it may be concluded that the image vector and the search vector meet a designated relationship. It may be seen that, by using the image vector representing the image and the text of the image, the result obtained by query is more comprehensive and accurate.

In an example embodiment, the image vector may represent image content feature information of the image and the text of the image. That is, the image vector may be generated based on the image content feature information of the image and the text of the image. As such, the accuracy of the matching operation performed by the query module 114 may be improved.

In this example embodiment, the image content feature information may include a content label of the image. The step of identifying the image content information of the image to obtain the image content feature information of the image may include the following steps.

1) The stock image is inputted to an image content labeling model to obtain an image content label of the stock image.

2) The image content label is used as image content feature information of the stock image.

For example, the image content labeling model may be determined in the following manner:

1) An image set including an image content label is collected.

2) The image set is trained by using a convolutional neural network, to obtain an image content labeling model.

In an actual application, content information corresponding to some images is known, and image content information of the images with known content information may be labeled in advance, so as to obtain images including image content labels. Correspondingly, a large number of image sets including content labels of images may be collected in advance, to serve as samples for training the image content labeling model subsequently.

In some example embodiments, the image set including the image content label may be inputted to a preset convolutional neural network for training, and parameters of each layer in the convolutional neural network are adjusted until an image content label currently outputted by the convolutional neural network matches with a preset image content label, and the convolutional neural network corresponding to the image content label outputted currently is used as the image content labeling model.

During training of the image content labeling model, a large number of image sets including image content labels are used as training samples directly, to effectively guarantee that the image content labeling model may identify image content labels of images accurately.

In this example embodiment, the matching operation may include, but is not limited to: when a sum of corresponding bits of the search vector and the image vector is greater than a designated threshold, it may be considered that the search vector matches the image vector; when a value of a sum of results obtained by performing subtraction on corresponding bits of the search vector and the image vector is greater than or equal to or less than a designated threshold, it may be considered that the search vector matches the image vector; an inner product of the search vector and the image vector is obtained, that is, products of corresponding bits are summed integrally, and when an obtained value is greater than or equal to a designated threshold, it may be considered that the search vector matches the image vector. Certainly, there may be other algorithms, and those skilled in the art may further have other changes in the light of the technical essence of the present application. The changes should all be encompassed in the protection scope of the present application as long as functions and effects implemented by the changes are identical or similar to those of the present disclosure.

The output module 116 may send the result set obtained by the query module 114 to the client terminal that sends the query request. As such, the client terminal may further acquire the image according to the access identifier in the obtained result set. The output module 116 may send the result of the query module 114 to the client terminal based on a network communication protocol. For example, the network communication protocol includes, but is not limited to, HTTP, TCP/IP, and the like.

Certainly, those skilled in the art may make other changes based on the technical solutions disclosed in the present disclosure. For example, the technical solution described in the present disclosure may also be applied in a scenario of searching for an “image” by using an “image”. The query request may carry an image, and then a search vector may be generated according to the image. Or, the query request may directly carry a search vector generated according to an image. The query module 114 may perform a matching operation between the search vector and an image vector in an index. The image vector may represent an image and a text; therefore, matching may be performed on the search vector from more aspects, such that more results with better accuracy are obtained.

The example embodiments of the present disclosure further provide an image search system. The image search system may include a service server and a search engine.

The service server is configured to receive a query request carrying a keyword and provided by a client terminal; provide the keyword or a search vector capable of representing the keyword to the search engine; and feed an obtained result set back to the client terminal.

In this example embodiment, the service server may be an electronic device having operation and network interaction functions, or software that runs in the electronic device and provides support for data processing and network interaction.

In this example embodiment, the number of servers in the service server is not limited. The service server may be one server, or several servers, or a server cluster formed by several servers.

In this example embodiment, the service server may be a service server of an e-commerce website platform. As such, the client terminal may communicate with the service server directly through the network. The keyword is sent to the service server, such that the service server may directly send an obtained result set to the client terminal.

In this example embodiment, the service server may include the request receiving module 110 and the output module 116. Certainly, the service server may further include the search vector generation module 112.

In this example embodiment, the client terminal may be an electronic device having display, operation and network access functions. For example, the client terminal may be a desktop computer, a tablet computer, a notebook computer, a smart phone, a digital assistant, a smart wearable device, a shopping guide terminal, and a television having a network access function. Or, the client terminal may also be software that may run in the foregoing electronic device.

The search engine may generate a search vector according to the keyword provided by the service server or receive a search vector provided by the service server; perform searching and matching in an index by using the search vector, so as to obtain a result set; and feed the result set back to the service server. The result set at least includes an access identifier corresponding to an image vector matching the search vector. As such, after the result set is provided to the client terminal, the client terminal may acquire a corresponding image according to the access identifier. Or, after receiving the result set, the service server may send an image corresponding to the access identifier to the client terminal.

In this example embodiment, the search engine may include the foregoing query module 114. Certainly, the search vector generation module 112 may also be disposed in the search engine, instead of being disposed in the service server.

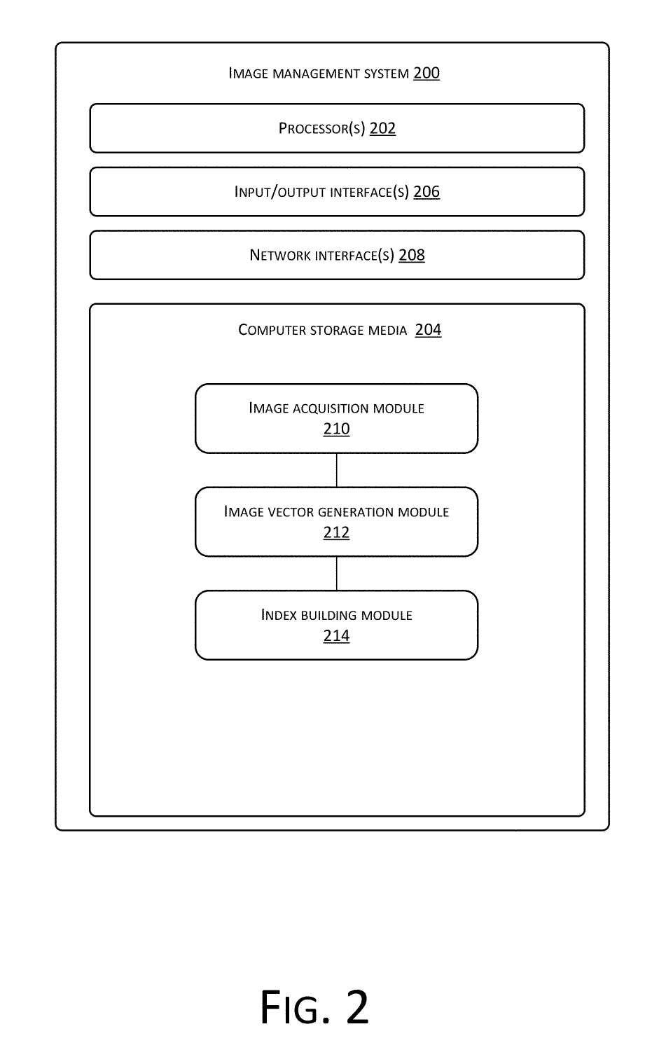

Referring to FIG. 2 and FIG. 5, the example embodiments of the present disclosure further provide an image management system 200. The image management system 200 includes one or more processor(s) 202 or data processing unit(s) and computer storage media 204. The image management system 200 may further include one or more input/output interface(s) 206 and one or more network interface(s) 208.

The computer storage media 204 may store therein a plurality of modules or units including an image acquiring module 210, an image vector generation module 212, and an index building module 214.

The image acquiring module 210 may acquire an image and a text corresponding to the image. The text may include a title of the image and/or characters surrounding the image when the image is displayed. For example, the image acquiring module 210 may capture a picture and a text corresponding to the picture over the Internet. The image acquiring module 210 may also read an image and a text of the image from a website platform. For example, JD.COM may be provided with a database of images and texts for the images, and a server of JD.COM may run the image acquiring module 210 to read the images in the database and the texts.

The image vector generation module 212 may generate an image vector according an image and a text of the image. The text of the image may be a title of the image, or characters surrounding the image when the image is displayed on an interface, or a label for marking content of the image. The label may be generated through identification by using a computer algorithm, or the image may be labeled manually. The image vector generation module 212 may extract a feature of the image and a feature of the text separately and generate the image vector according to the extracted features. The image vector generation module 212 may include an image representation unit, a text representation unit, and a synthesis unit.

In this example embodiment, the image representation unit may extract features from the image to generate an image representation vector. The image representation unit may extract features of the image in multiple dimensions in the process of generating the image representation vector. A feature value may be obtained in each dimension, such that the feature values are arranged according to a certain sequence to form the image representation vector. Therefore, the image representation vector is used to represent the image. For example, the image representation unit may perform dimension-reduction processing on a pixel matrix of the image in different dimensions based on different mapping algorithms or convolutional matrices, thus obtaining a feature value of each dimension.

In this example embodiment, the text representation unit may generate a text representation vector according to the text related to the image. The text representation unit may integrate a title of the image and characters displayed surrounding the image and perform feature extraction to generate a text representation vector. The text representation unit may also perform word segmentation on the text of the image to obtain several terms and generate a term representation value for each term. The obtained term feature values are arranged according to a certain sequence to form the text representation vector. Certainly, the text of the image or the several terms obtained by performing word segmentation on the text may be used as an input of a deep learning algorithm such as a neural network, and the text representation vector is outputted by using the deep learning algorithm. As such, the text representation vector is used to represent the text.

In this example embodiment, the synthesis unit may integrate the image representation vector and the corresponding text representation vector to generate the image vector. The text representation vector corresponding to the image representation vector may be a text representation vector that is used to indicate text information of the image indicated by the image representation vector.

In this example embodiment, the synthesis unit may integrate the image representation vector and the text representation vector into an image vector according to a certain algorithm. The algorithm may include: performing weighted addition on corresponding bits of the image representation vector and the text representation vector to obtain a vector serving as an image vector; and performing subtraction on the corresponding bits of the image representation vector and the text representation vector to obtain a vector serving as an image vector. The synthesis unit may further directly integrate the image representation vector with the text representation vector sequentially to form a vector serving as an image vector. The sequential order of the image representation vector and the text representation vector may be set according to a specific requirement.

In this example embodiment, the index building module 214 may build an index according to the image vector and an access identifier of the image. The index may include an image vector and an access identifier of an image represented by the image vector that are recorded correspondingly. As such, the index may be provided to the image search system, and the search engine may perform a matching operation between the search vector and the image vector in the index to obtain a result set.

FIG. 5 illustrates schematic diagram of a relationship between vectors according to an example embodiment of the present disclosure. The search vector generation module 112 generates a search vector 502 according to a query request 504. The search vector generation module 112 may generate the search vector 502 based on the entire query request or a keyword carried by the query request 504.

The image vector generation module 212 generates an image vector 506 according an image 508 and a text 510 of the image 508. The text 510 of the image 508 may be a title of the image 508, or characters surrounding the image 508 when the image 508 is displayed on an interface, or a label for marking content of the image 508. The label may be generated through identification by using a computer algorithm, or the image 508 may be labeled manually. The image vector generation module 212 may extract a feature of the image 508 and a feature of the text 510 separately and generate the image vector 506 according to the extracted features.

In this example embodiment, the search vector 502 and the image vector 506 are located in the same vector space 512

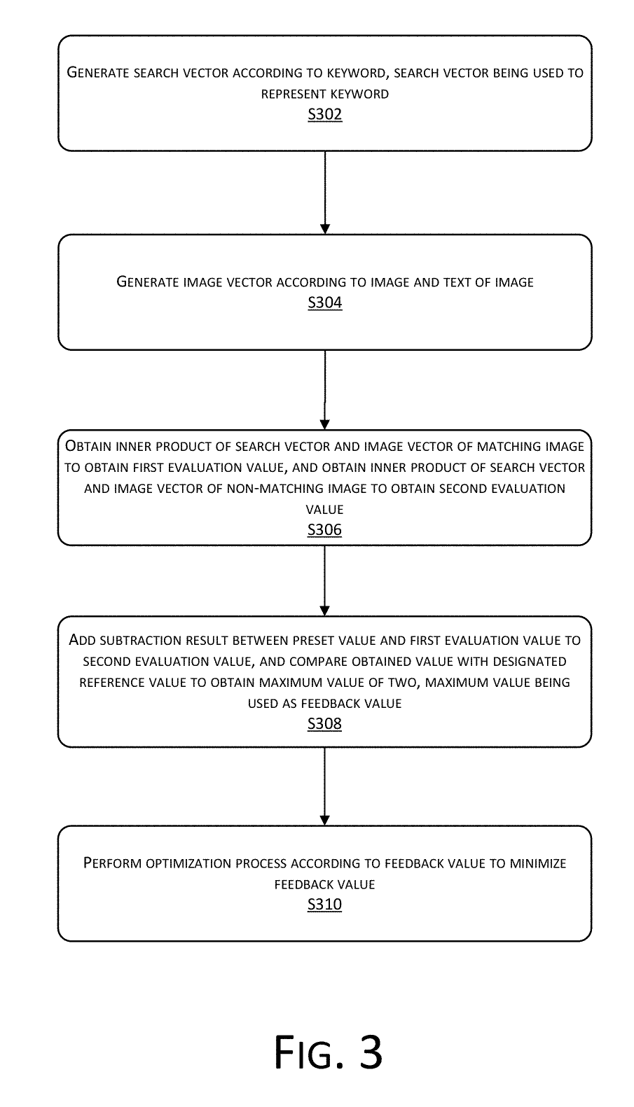

Referring to FIG. 3, the example embodiments of the present disclosure further provide a method for optimizing an image search process. A keyword for querying an image and a known image set having a matching relationship with the keyword are provided. The image set includes an image and a text for the image.

In this example embodiment, the matching relationship may be a result obtained by performing a matching operation between a search vector and an image vector, which may include matching and non-matching. The optimization method may include the following steps:

Step S302: A search vector is generated according to the keyword, the search vector being used to represent the keyword.

In this example embodiment, the number of samples serving as keywords is not limited. It is possible to generate one search vector corresponding to each keyword. It is also possible to generate one search vector for multiple keywords that tend to have identical semantic meanings.

Step S304: An image vector is generated according to the image and the text setoff the image. For example, the text is description information of the image.

Step S306: An inner product of the search vector and an image vector of a matching image is obtained to obtain a first evaluation value, and an inner product of the search vector and an image vector of a non-matching image is obtained to obtain a second evaluation value.

Step S308: A subtraction result of a preset value and the first evaluation value is added to the second evaluation value, and an obtained value is compared with a designated reference value to obtain the maximum value, wherein the maximum value is used as a feedback value.

In this example embodiment, the feedback value may be a result of one operation; or a sum of feedback values that are obtained by performing operations on multiple samples may serve as a final feedback value.

Step S310: An optimization process is performed according to the feedback value to minimize the feedback value.

In this example embodiment, a smaller feedback value represents a greater first evaluation value and a smaller second evaluation value. As such, it may be indicated that the inner product of the search vector and the image vector of the matching image is greater, and the inner product of the search vector and the image vector of the non-matching image is smaller. As such, it is easy to distinguish an image matching the search vector from an image not matching the search vector during the image search, thus improving the accuracy of the image search.

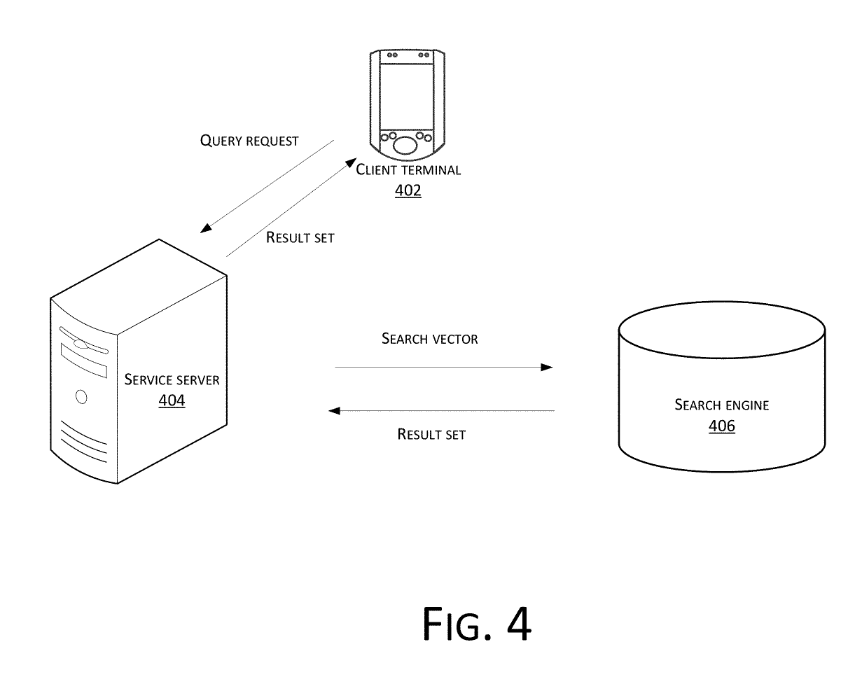

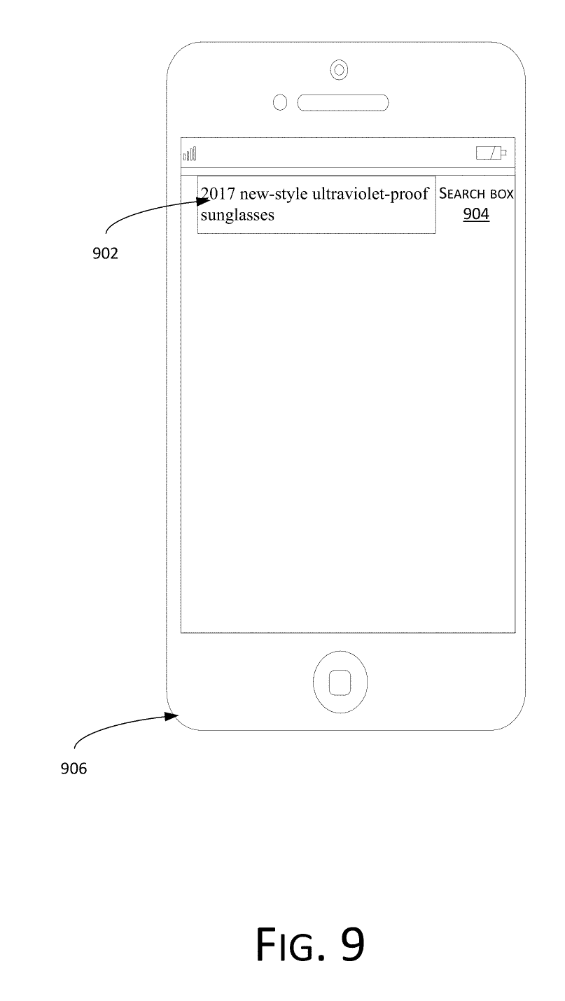

Referring to FIG. 4 and FIG. 9, in a scenario example, a user operates a client terminal 402 to send a query request to a service server 404. The query request may carry a keyword such as “2017 new-style ultraviolet-proof sunglasses”.

In this scenario example, as shown in FIG. 9, after receiving the keyword “2017 new-style ultraviolet-proof sunglasses” 902 input into a search box 904 at the user interface from the client terminal 906, the service server 404 may perform word segmentation on the keyword. The keyword is word-segmented into sub-keywords including “2017”, “new-style”, “proof”, “ultraviolet”, “sunglasses”, and the like.

In this scenario example, the service server 404 may generate a search vector based on the LSTM network algorithm by using the sub-keywords as an input. For example, the sub-keywords may be converted into word vectors by using one-hot encoding, and a word vector group is used as an input of the LSTM network.

In this scenario example, after receiving the search vector provided by the service server 404, the search engine 406 may perform a matching operation on the search vector in an index that is built in advance. The index correspondingly records an image vector and an access identifier. The image vector is generated according to an image and a text of the image, such that the image vector may represent the image and the text of the image. The search vector and the image vector may be located in the same vector space, such that a matching operation may be performed between the search vector and the image vector. The access identifier may be a URL of the image.

In this scenario example, the image vector may include a first data segment and a second data segment, the first data segment being used to represent an image, and the second data segment being used to represent a text of the image. The first data segment and the second data segment may be both located in the same vector space with the search vector. As such, the search engine 406 may perform a matching operation between the search vector and the first data segment as well as the second data segment of the image vector respectively.

In this scenario example, for example, a search vector is {1,0,3,2}, and four image vectors in an index are {2,1,1,3:0,4,9,6}, {1,4,1,1:1,5,7,3}, {3,1,5,2:1,9,0,0}, and {1,5,1,0:0,9,2,1} respectively. The matching algorithm may be comparing a value of an inner product with a designated threshold, and it is considered that the search vector matches the image vector when the obtained value is greater than the designated threshold. For example, the designated threshold may be 10. A value of an inner product of the search vector {1,0,3,2} and a first data segment {2,1,1,3} of the first image vector is 11, and a value of an inner product of the search vector and a second data segment is 39. It may be seen that the first data segment and the second data segment of the first image vector both match the search vector, and it is considered that the first image vector matches the search vector. An access identifier corresponding to the first image vector is put into a result set of the current search. Values obtained by performing a matching operation respectively between the search vector and a first data segment as well as a second data segment of the second image vector are 6 and 28 respectively. In this case, as the operational value of the search vector and the second data segment is greater than the designated threshold, an access identifier corresponding to the second image vector is put into the result set. Values obtained by performing a matching operation respectively between the search vector and a first data segment as well as a second data segment of the third image vector are 22 and 1 respectively. In this case, as the operational value of the search vector and the first data segment is greater than the designated threshold, an access identifier corresponding to the third image vector is put into the result set. Values obtained by performing a matching operation respectively between the search vector and a first data segment as well as a second data segment of the fourth image vector are 4 and 8 respectively. In this case, as the operational value of the search value and the first data segment and the operational value of the search value and the second data segment are both less than the designated threshold, it is considered that the search vector does not match the fourth image vector.

In this scenario example, after completing the image search, the search engine 406 feeds the result set back to the service server 404. The service server 404 may directly send a corresponding image to the client terminal 402 according to the access identifier of the result set, or directly send the result set to the client terminal 404 such that the client terminal may further acquire the image according to the access identifier in the result set.

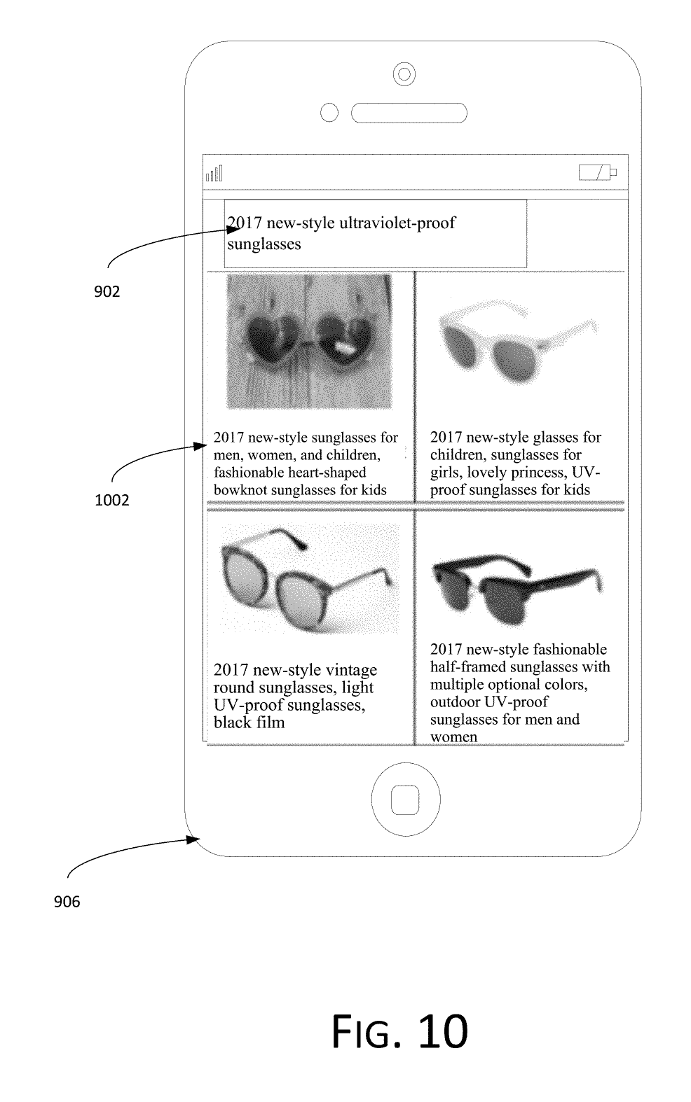

Referring to FIG. 10, in this scenario example, the result set received by the client terminal 906 includes the access identifier of the image. The client terminal 906 sends an access request to each access identifier, so as to obtain a corresponding image and display the image. When acquiring the image, the client terminal may also acquire a text of the image. As such, during display, the image and the text may be displayed correspondingly in a display interface 1002 as shown in FIG. 10.

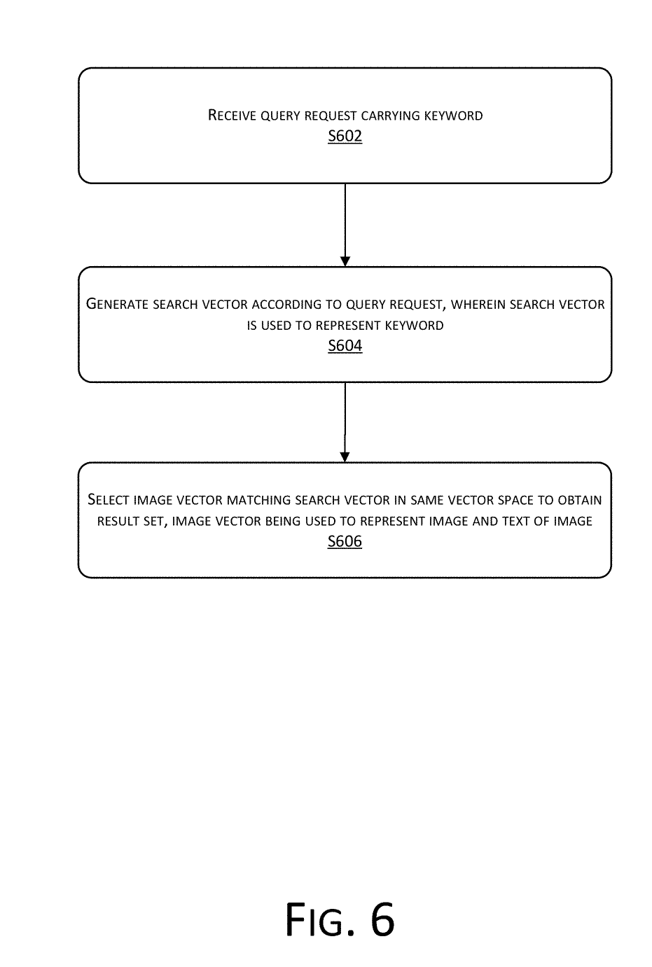

Referring to FIG. 6, the example embodiments of the present disclosure further provide an image search method. The image search method may include the following steps.

Step S602: A query request carrying a keyword is received.

Step S604: A search vector is generated according to the query request, wherein the search vector is used to represent the keyword.

Step S606: An image vector matching the search vector is selected in the same vector space to obtain a result set, the image vector being used to represent an image and a text of the image.

The search vector is matched from an index to obtain a result set. The index records an image vector and a corresponding access identifier of an image represented by the image vector. The result set at least includes an access identifier corresponding to an image vector matching the request vector; and the image vector is used to represent an image and description information of the image

In this example embodiment, by adopting an image vector that may represent an image and a text of the image, the accuracy of an image obtained by query may be improved when a matching operation is performed between a search vector of a keyword and the image vector during selection of the image vector matching the search vector. That is, when the search vector matches the image vector, it is possible that: content of the image is associated with the semantic meaning of the keyword; or content of the text is associated with the semantic meaning of the keyword; or content of the image and content of the text are both associated with the semantic meaning of the keyword. As may be seen, the image search method may provide better experience for users.

This example embodiment may be explained with reference to other example embodiments.

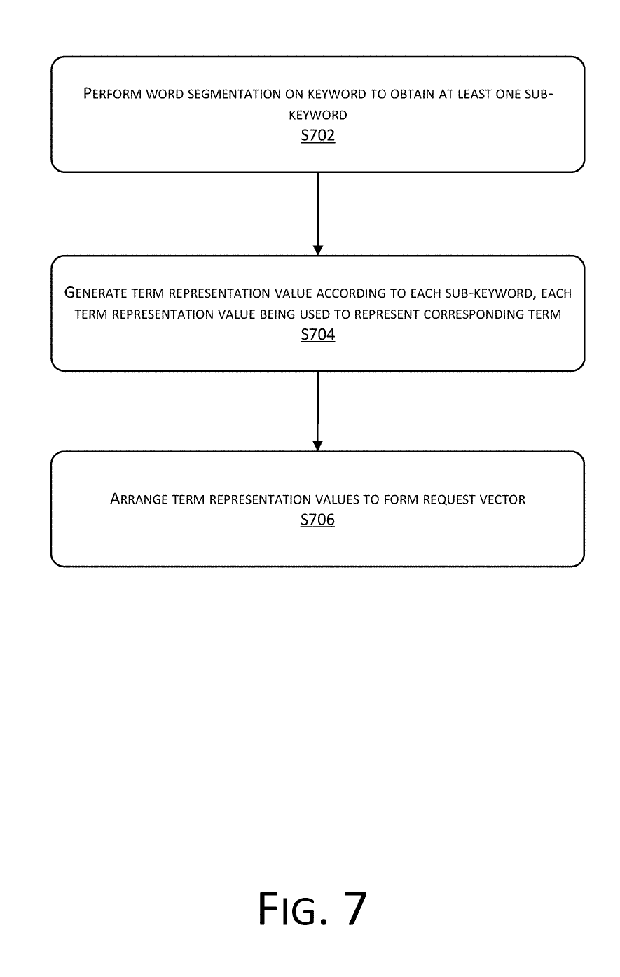

Referring to FIG. 7, in an example embodiment, the step of generating the search vector may include the following steps.

Step S702: Word segmentation is performed on the keyword to obtain at least one sub-keyword.

In this example embodiment, the keyword may be word-segmented based on the semantic meaning of a natural language. When the keyword includes multiple natural phrases, each natural phrase may be used as a sub-keyword. For example, the keyword may be “interesting children's English picture book”, which may be divided into sub-keywords such as “interesting”, “children”, “English”, and “picture book”. Certainly, when the keyword is a natural phrase as a whole, the keyword cannot be divided. For example, the keyword may be “bus”.

Step S704: A term representation value is generated according to each sub-keyword, each term representation value being used to represent a corresponding term.

Step S706: The term representation values are arranged to form the search vector.

In this example embodiment, the term representation values may be generated by using a neural network algorithm. For example, the term representation value may be generated according to an LSTM network algorithm improved based on the RNN algorithm. Each sub-keyword may be used as an input of a neuron, and data outputted after the neuron performs an operation is a term representation value of the sub-keyword. Neurons on the same level may have an upstream-downstream relationship, that is, an upstream neuron performs an operation according to the inputted sub-keyword and then outputs a conduction value to an adjacent downstream neuron. As such, the outputted term representation value may take into consideration both the sub-keyword itself and the context semantic meaning of the keyword that includes the sub-keyword. Therefore, the generated search vector may represent the keyword more accurately.

In this example embodiment, the manner of arranging the term representation values may include: arranging according to a sequential order of generating the term representation values; and arranging according to numerical magnitudes of the term representation values. Moreover, the term representation values may also be arranged according to a sequence of the sub-keywords represented by the term representation values in the keyword. As such, the generated search vector may represent the keyword more accurately.

In an example embodiment, the step of performing a matching operation may include at least one of the following: summing corresponding bits of the search vector and the image vector, and when an obtained value is greater than or equal to a first designated threshold, considering that the image vector matches the search vector; or summing values obtained by performing subtraction on corresponding bits of the search vector and the image vector, and when an obtained value is less than a second designated threshold, considering that the image vector matches the search vector; or obtaining an inner product of the search vector and the image vector, and when an obtained value is greater than or equal to a third designated threshold, considering that the image vector matches the search vector.

In this example embodiment, the first designated threshold, the second designated threshold, and the third designated threshold may be constants set according to actual requirements. The constants may be set according to experience of workers or obtained statistically according to an actual running effect of a program.

In an example embodiment, the image vector includes a first data segment and a second data segment. The first data segment is used to represent an image, and the second data segment is used to represent a text of the image. During the matching operation, the matching operation is performed between the search vector and the first data segment as well as the second data segment of the image vector respectively; and it is considered that the search vector matches the image vector when the search vector matches one of the first data segment and the second data segment.

In this example embodiment, the first data segment may be an image representation vector. The second data segment may be a text representation vector. As such, the first data segment may be used to represent the image. The second data segment may be used to represent a text of the image.

In this example embodiment, the first data segment and the second data segment may be both located in the same vector space with the search vector. As such, it is implemented that the search vector and the image vector are located in the same vector space.

In this example embodiment, during the matching operation, it is considered that the search vector matches the image vector when at least one the first data segment and the second data segment matches the search vector. As such, it may be implemented that: when content of the image is associated with the semantic meaning of the keyword, it is considered that the image vector matches the search vector; or when content of the text is associated with the semantic meaning of the keyword, it is considered that the image vector matches the search vector; or when content of the image and content of the text are both associated with the semantic meaning of the keyword, it is considered that the image vector matches the search vector. Therefore, more results with better accuracy may be obtained by searching.

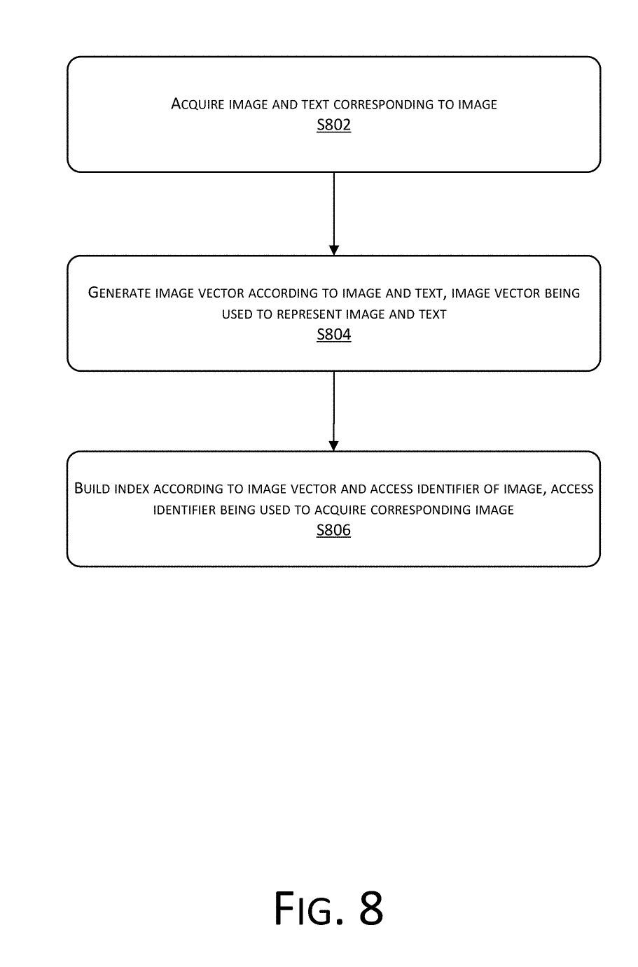

Referring to FIG. 8, the example embodiments of the present disclosure provide an index building method, which may include the following steps.

Step S802: An image and a text of the image are acquired. For example, the text is description information of the image.

Step S804: An image vector is generated according to the image and the text, the image vector being used to represent the image and the text.

Step S806: An index is built according to the image vector and an access identifier of the image, wherein the access identifier is used to acquire the corresponding image.

In this example embodiment, the image vector may simultaneously represent the image and the text of the image. As such, the image vector may represent the image more accurately. Therefore, when a matching operation is performed between the search vector and the index generated according to the image vector, a more accurate result may be obtained.

The example embodiments of the present disclosure further provide a computer storage medium, wherein the computer storage medium stores computer-readable instructions, and when being executed by a processor, computer-readable instructions implements: acquiring an image corresponding and a text corresponding to the image; generating an image vector according to the image and the text, the image vector being used to represent the image and the text; and building an index according to the image vector and an access identifier of the image, wherein the access identifier is used to acquire the corresponding image.

In this example embodiment, the computer storage medium includes, but is not limited to, a Random Access Memory (RAM), a Read-Only Memory (ROM), a Cache, a Hard Disk Drive (HDD), or a Memory Card.

The terms and the implemented functions and effects in this example embodiment may be explained with reference to other example embodiments.

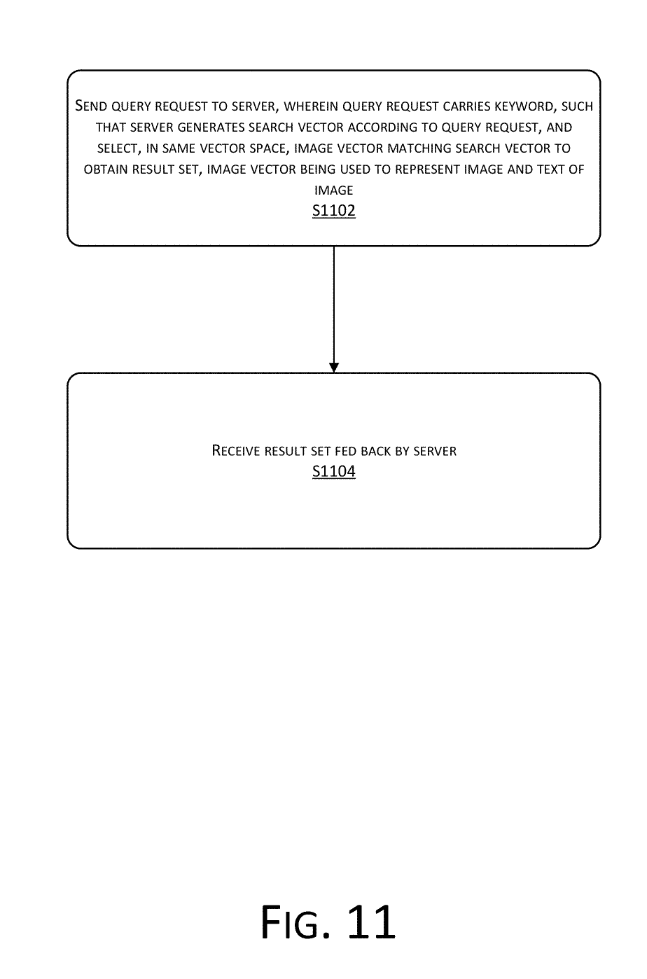

Referring to FIG. 11, the example embodiments of the present disclosure further provide an image search method. The method may include the following steps.

Step S1102: A query request is sent to a server, wherein the query request carries a keyword, such that the server generates a search vector according to the query request, and selects, in the same vector space, an image vector matching the search vector to obtain a result set, the image vector being used to represent an image and a text of the image.

Step S1104: The result set fed back by the server is received.

In this example embodiment, the result set received by the client terminal may include an access identifier. The client terminal may acquire a corresponding image according to the access identifier. Then, the image may be displayed at the client terminal. For example, the access identifier may be a URL of an image, and the client terminal sends an access request to the URL, so as to obtain a corresponding image and display the image.

The terms and the implemented functions and effects in this example embodiment may be explained with reference to other example embodiments.

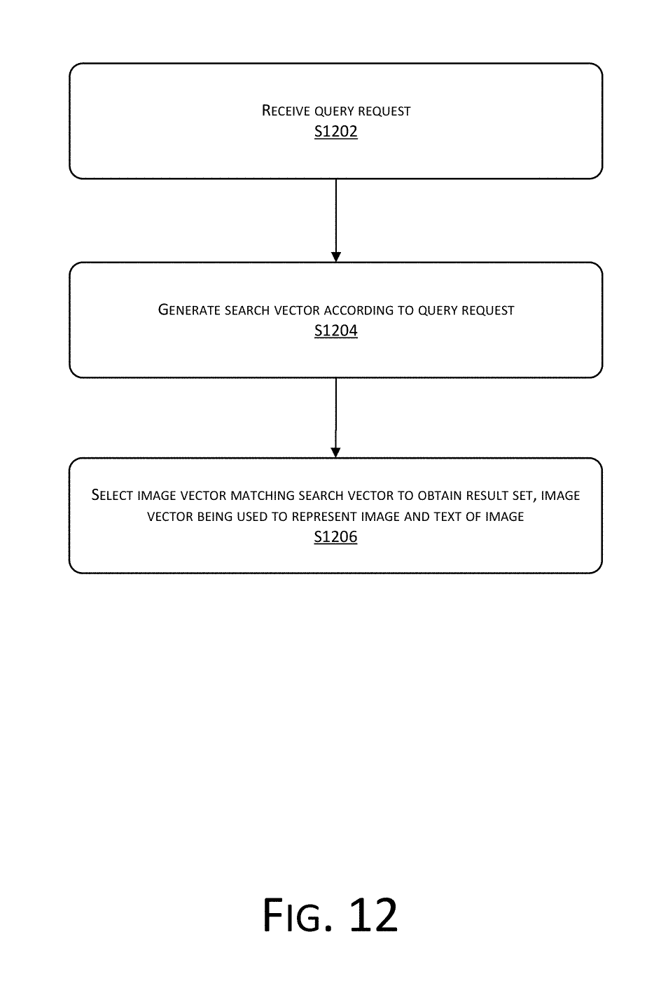

Referring to FIG. 12, the example embodiments of the present disclosure provide an image search method, which may include the following steps.

Step S1204: A query request is received.

Step S1204: A search vector is generated according to the query request.

In this example embodiment, the query request may carry a keyword, such that the query request may have a certain semantic meaning. Certainly, the query request may not carry a keyword, and may represent a certain semantic meaning by setting a special format for the query request.

In this example embodiment, the manner of generating a search vector based on the query request may include: performing word segmentation on the query request or the keyword carried by the query request, and performing corresponding processing after the word segmentation to form a search vector; or generating a search vector directly based on the entire keyword in the query request; or generating a search vector based on the entire query request.

Step S1206: An image vector matching the search vector is selected to obtain a result set, the image vector being used to represent an image and a text of the image.

In this example embodiment, the search vector and the image vector may be mapped into the same vector space to perform a matching operation. Or, by using an operational algorithm, a matching operation may be directly performed on the search vector and the image vector without mapping them into the same vector space. For example, an algorithm for mapping the search vector or the image vector to a designated space may be combined with a matching algorithm to perform an operation directly, and it is unnecessary to map the search vector and the image vector to the designated space before performing the matching operation.

The terms and the implemented functions and effects in this example embodiment may be explained with reference to other example embodiments.

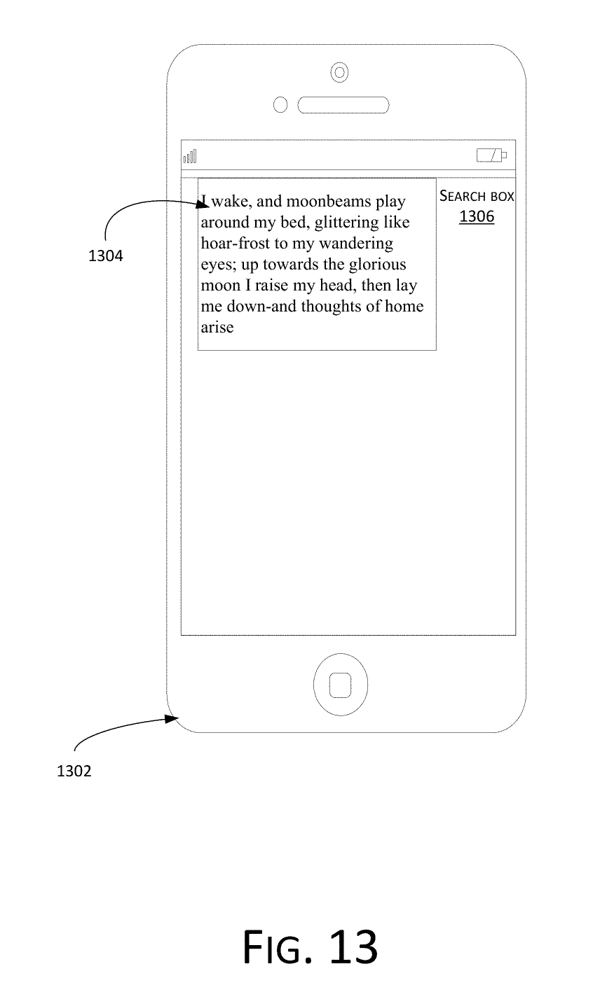

Refer to FIG. 13, in a scenario example, a user uses a client terminal 1302 to perform image search, to obtain an image matching a text.

In this scenario example, the user may input the text such as “I wake, and moonbeams play around my bed, glittering like hoar-frost to my wandering eyes; up towards the glorious moon I raise my head, then lay me down-and thoughts of home arise” 1304 into a search box 1306 at a user interface of the client terminal 1302. The user needs to find an image matching this poem. The client terminal sends a query request to a service server by using the poem inputted by the user as a keyword carried in the query request.

In this scenario example, after receiving the query request, the service server obtains the keyword “I wake, and moonbeams play around my bed, glittering like hoar-frost to my wandering eyes; up towards the glorious moon I raise my head, then lay me down-and thoughts of home arise.” The entire keyword may be inputted to a neural network algorithm to obtain a search vector that may represent the keyword. The service server provides the search vector to a search engine so that a further matching operation is performed.

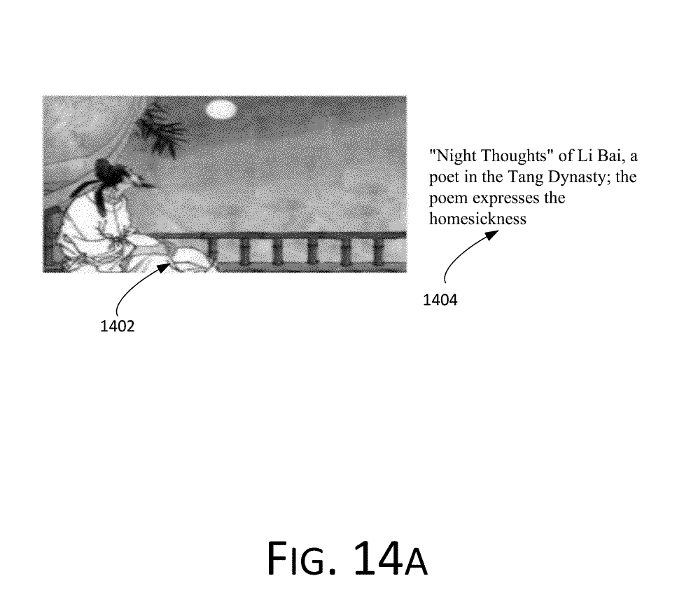

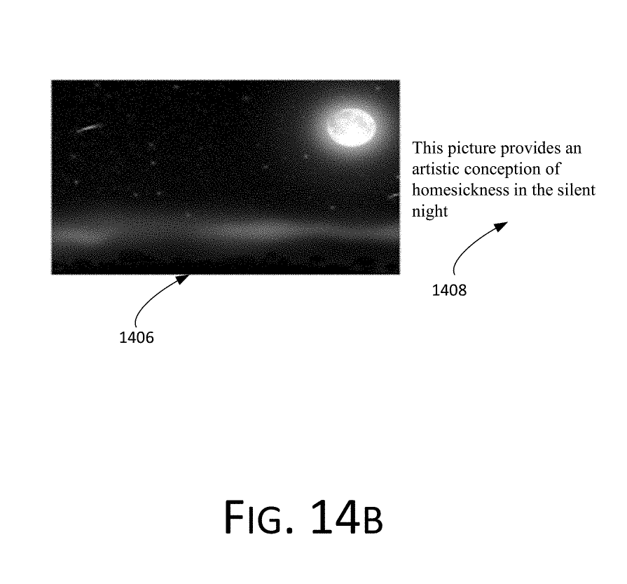

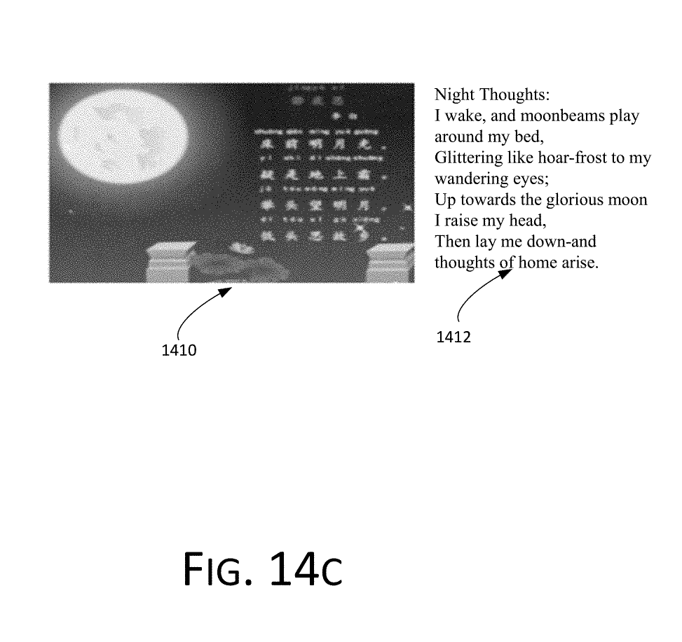

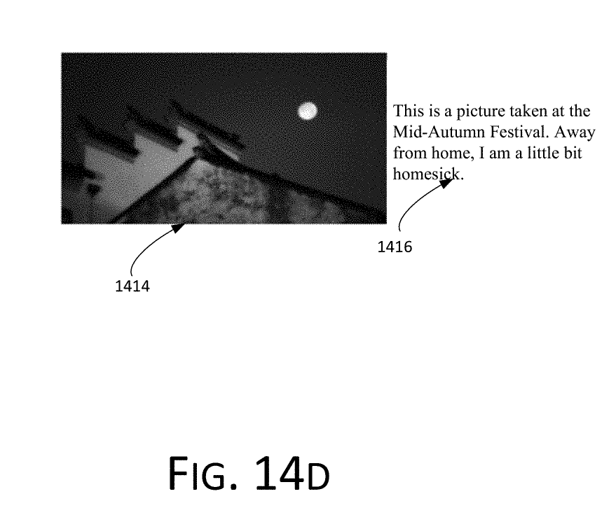

In this scenario example, the search engine matches the search vector with the image vector in the index. The image vector may represent an image and a text of the image. After the matching operation, matching is performed between the image vectors of the images and the texts as shown in FIG. 14a, FIG. 14b, FIG. 14c, and FIG. 14d and the search vector.

The text 1304 “I wake, and moonbeams play around my bed, glittering like hoar-frost to my wandering eyes; up towards the glorious moon I raise my head, then lay me down-and thoughts of home arise” is the full text of Night Thoughts written by the poet Li Bai.

FIG. 14a shows an image 1402 that illustrates a poet looking at the moon and a corresponding text 1404 “‘Night Thoughts’ of Li Bai, a poet in the Tang Dynasty; the poem expresses the homesickness” that describes the image 1402.

FIG. 14b shows an image 1406 that illustrates moon and a corresponding text 1408 “This picture provides an artistic conception of homesickness in the silent night” that describes the image 1406.

FIG. 14c shows an image 1410 that illustrates moon and the full text of “Night Thoughts” in Chinese characters, and a corresponding text 1412 “Night Thoughts: I wake, and moonbeams play around my bed, glittering like hoar-frost to my wandering eyes; Up towards the glorious moon I raise my head, then lay me down-and thoughts of home arise” that is the full text of “Night Thoughts.”

FIG. 14d shows an image 1414 that illustrates a building and moon at night and a corresponding text 1416 “This is a picture taken at the Mid-Autumn Festival. Away from home, I am a little bit homesick.”

The search engine may put access identifiers corresponding to the image vectors into a result set, to provide the result set to the service server.

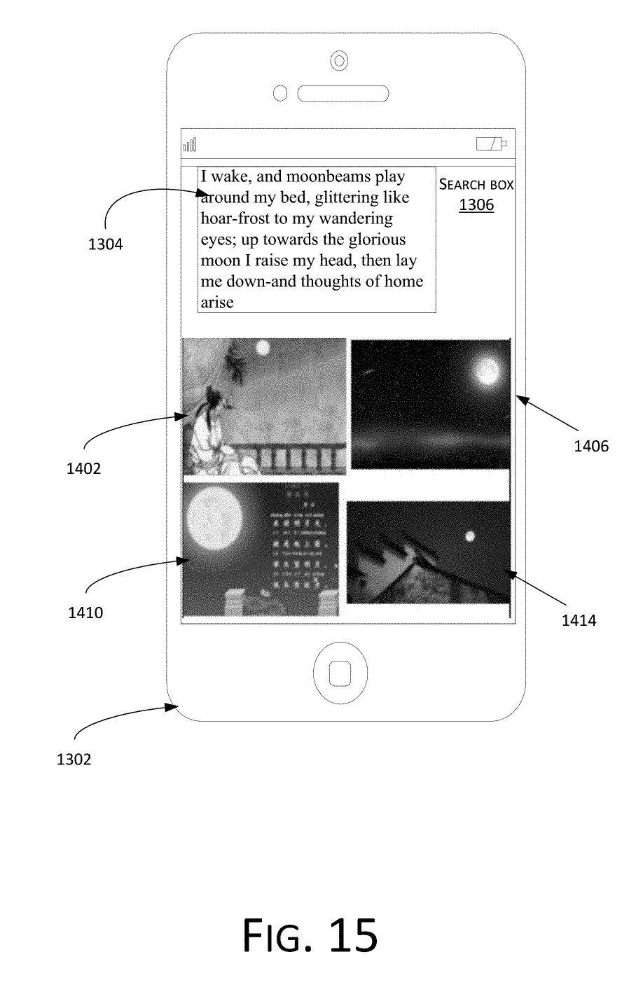

In this scenario example, the service server may provide the result set to the client terminal. Referring to FIG. 15, the result set includes the corresponding images 1402, 1406, 1410, and 1414 are presented at the user interface 1302. The client terminal further acquires a corresponding image according to the access identifier (in this example, the image snapshots are acted as the access identifiers) and displays the image. Further, the user may select one or more of the images by operating the client terminal, and use the one or more images as the image matching the keyword.

Various example embodiments in the present disclosure are described in a progressive manner. The same or similar parts between the example embodiments may be referenced to one another. In each example embodiment, the portion that is different from other example embodiments is mainly described.

The server mentioned in the example embodiments of the present disclosure may be an electronic device having a certain operational processing capability, which may have a network communication terminal, a processor, a memory, and the like. Certainly, the server may also refer to software run in the electronic device. The server may also be a distributed server, which may be a system having multiple processors, memories, and network communication modules that run cooperatively.

In the 1990s, an improvement on a technology may be obviously distinguished as an improvement on hardware (for example, an improvement on a circuit structure such as a diode, a transistor, and a switch) or an improvement on software (an improvement on a method procedure). However, with the development of technologies, improvements of many method procedures at present may be considered as direct improvements on hardware circuit structures. Almost all designers program the improved method procedures into hardware circuits to obtain corresponding hardware circuit structures. Therefore, it is improper to assume that the improvement of a method procedure cannot be implemented by using a hardware entity module. For example, a Programmable Logic Device (PLD) (for example, a Field Programmable Gate Array (FPGA)) is such an integrated circuit, and logic functions thereof are determined by a user programming device. Designers program by themselves to “integrate” a digital system into a piece of PLD, without the need to ask a chip manufacturer to design and manufacture a dedicated integrated circuit chip 2. Moreover, at present, the programming is mostly implemented by using logic compiler software, instead of manually manufacturing an integrated circuit chip. The logic compiler software is similar to a software complier used for developing and writing a program, and original codes before compiling also need to be written by using a specific programming language, which is referred to as a Hardware Description Language (HDL). There are many types of HDLs, such as Advanced Boolean Expression Language (ABEL), Altera Hardware Description Language (AHDL), Confluence, Cornell University Programming Language (CUPL), HDCal, Java Hardware Description Language (JHDL), Lava, Lola, MyHDL, PALASM, and Ruby Hardware Description Language (RHDL), among which Very-High-Speed Integrated Circuit Hardware Description Language (VHDL) and Verilog2 are most commonly used now. Persons skilled in the art should also know that a hardware circuit for implementing the logic method procedure may be easily obtained by slightly logically programming the method procedure using the above several hardware description languages and programming it into an integrated circuit.

A person skilled in the art also knows that, in addition to implementing the controller by using pure computer readable program codes, the method steps may be logically programmed to enable the controller to implement the same function in a form of a logic gate, a switch, an application specific integrated circuit, a programmable logic controller and an embedded microcontroller. Therefore, this type of controller may be considered as a hardware component, and apparatuses included in the controller and used for implementing various functions may also be considered as structures inside the hardware component. Or, the apparatuses used for implementing various functions may even be considered as both software modules for implementing the method and structures inside the hardware component.

Through the description of the foregoing implementation manners, those skilled in the art may clearly understand that the present disclosure may be implemented by software plus a necessary universal hardware platform. Based on such understanding, the technical solution of the present disclosure essentially, or the portion contributing to the conventional techniques may be embodied in the form of a software product. The software product may be stored in a storage medium, such as a ROM/RAM, a magnetic disk, or an optical disc, and include several instructions that enable a computer device (which may be a personal computer, a server, a network device, or the like) to execute the methods in the example embodiments or certain portions of the example embodiments of the present disclosure.

Although the present disclosure is described through the example embodiments, those of ordinary skill in the art should know that the present disclosure has many variations and changes without departing from the spirit of the present disclosure, and it is expected that the appended claims cover the variations and changes without departing from the spirit of the present disclosure.

The present disclosure may further be understood with clauses as follows.

Clause 1. An image search method, comprising:

receiving a query request carrying a keyword;

generating a search vector according to the query request, wherein the search vector is used to represent the keyword; and

selecting, in the same vector space, an image vector matching the search vector to obtain a result set, the image vector being used to represent an image and a text of the image.

Clause 2. The method of clause 1, wherein an index comprising the image vector and an access identifier is provided, the access identifier being used to access the image represented by the image vector; and

the step of selecting an image vector comprises: performing a matching operation between the image vector of the index and the search vector to obtain the result set, the result set at least comprising an access identifier corresponding to an image vector matching the search vector.

Clause 3. The method of clause 1, wherein the step of generating a search vector comprises: generating the search vector according to the keyword.

Clause 4. The method of clause 3, wherein the step of generating the search vector comprises:

performing word segmentation on the keyword to obtain at least one sub-keyword;

generating a term representation value according to each sub-keyword, each term representation value being used to represent a corresponding term; and

arranging the term representation values to form the search vector.

Clause 5. The method of clause 4, wherein the step of forming the search vector comprises: arranging the term representation values according to a sequence of the sub-keywords represented by the term representation values in the keyword.

Clause 6. The method of clause 1, wherein the step of selecting an image vector comprises:

summing corresponding bits of the search vector and the image vector, and considering that the image vector matches the search vector if an obtained value is greater than or equal to a first designated threshold; or

summing values obtained by performing subtraction on corresponding bits of the search vector and the image vector, and considering that the image vector matches the search vector if an obtained value is less than a second designated threshold; or

obtaining an inner product of the search vector and the image vector, and considering that the image vector matches the search vector when an obtained value is greater than or equal to a third designated threshold.

Clause 7. The method of clause 1, wherein the image vector comprises a first data segment and a second data segment, the first data segment being used to represent an image, and the second data segment being used to represent a text of the image; and

the step of performing a matching operation comprises: performing a matching operation between the search vector and the first data segment as well as the second data segment of the image vector respectively; and considering that the search vector matches the image vector when the search vector matches one of the first data segment and the second data segment.

Clause 8. The method of clause 1, further comprising: sending the result set to a client terminal providing the query request, such that the client terminal presents the image represented by the selected image vector.

Clause 9. An image search system, comprising:

a request receiving module configured to receive a query request carrying a keyword;

a search vector generation module configured to generate a search vector according to the query request, wherein the search vector is used to represent the keyword; and

a query module configured to select, in the same vector space, an image vector matching the search vector to obtain a result set, the image vector being used to represent an image and a text of the image.

Clause 10. The system of clause 9, further comprising:

an output module configured to send the result set to a client terminal sending the query request.

Clause 11. An image search system, comprising: a service server and a search engine, wherein

the service server is configured to receive a query request carrying a keyword and provided by a client terminal; generate, according to the query request, a search vector capable of representing the keyword, and provide the search vector to the search engine; and feed an obtained result set back to the client terminal; and

the search engine is configured to select, in the same vector space, an image vector matching the search vector to obtain a result set; and feed the result set back to the service server, wherein the image vector is used to represent an image and a text of the image.

Clause 12. An index building method, comprising:

acquiring an image and a text of the image;

generating an image vector according to the image and the text, the image vector being used to represent the image and the text; and

building an index according to the image vector and an access identifier of the image, wherein the access identifier is used to acquire the corresponding image.

Clause 13. The method of clause 12, wherein the step of generating an image vector comprises:

generating an image representation vector according to the image, the image representation vector being used to represent the image;

generating a text representation vector according the text, the text representation vector being used to represent the text; and

integrating the image representation vector and the text representation vector to obtain the image vector.

Clause 14. An image management system, comprising:

an image acquiring module configured to acquire an image and a text of the image;

an image vector generation module configured to generate an image vector according to the image and the text, the image vector being used to represent the image and the text; and

an index building module configured to build an index according to the image vector and an access identifier of the image, wherein the access identifier is used to acquire the corresponding image.

Clause 15. A computer storage medium, wherein the computer storage medium stores computer-readable instructions, and when being executed by a processor, computer-readable instructions implements the following steps: acquiring an image and a text of the image; generating an image vector according to the image and the text, the image vector being used to represent the image and the text; and building an index according to the image vector and an access identifier of the image, wherein the access identifier is used to acquire the corresponding image.

Clause 16. An image search method, comprising:

sending a query request to a server, wherein the query request carries a keyword, such that the server generates a search vector according to the query request, and selects, in the same vector space, an image vector matching the search vector to obtain a result set, the image vector being used to represent an image and a text of the image; and

receiving the result set fed back by the server.

Clause 17. An image search method, comprising:

receiving a query request;

generating a search vector according to the query request; and

selecting an image vector matching the search vector to obtain a result set, the image vector being used to represent an image and a text of the image.

What is claimed is:

1. A method comprising:
receiving a query request carrying a keyword;
generating a search vector that represents the keyword; and
selecting, in a same vector space, an image vector matching the search vector to obtain a result set.

2. The method of claim 1, wherein the image vector represents an image and a text of the image.

3. The method of claim 1, further comprising:
providing an index that includes the image vector and an access identifier, the access identifier being used to access the image represented by the image vector.

4. The method of claim 3, wherein the selecting the image vector includes:
performing a matching operation between the image vector and the search vector to obtain a result set, the result set including the access identifier corresponding to the image vector matching the search vector.

5. The method of claim 1, wherein the generating the search vector includes generating the search vector according to the keyword.

6. The method of claim 1, wherein the generating the search vector includes:
performing word segmentation on the keyword to obtain at least one sub-keyword;
generating a respective term representation value according for a respective sub-keyword, the respective term representation value representing a corresponding term; and
arranging term representation values to form the search vector.

7. The method of claim 6, wherein the arranging the term representation values to form the search vector includes:
arranging the term representation values according to a sequence of the sub-keywords represented by the term representation values in the keyword.

8. The method of claim 1, wherein the selecting the image vector includes:
summing corresponding bits of the search vector and the image vector;
determining that obtained value is greater than or equal to a first designated threshold; and
determining that the image vector matches the search vector.

9. The method of claim 1, wherein the selecting the image vector includes:
summing values obtained by performing subtraction on corresponding bits of the search vector and the image vector;
determining that an obtained value is less than a second designated threshold; and
determining that the image vector matches the search vector.

10. The method of claim 1, wherein the selecting the image vector includes:
obtaining an inner product of the search vector and the image vector;
determining that an obtained value is greater than or equal to a third designated threshold; and
determining that the image vector matches the search vector.

11. The method of claim 1, wherein:
the image vector includes a first data segment and a second data segment, the first data segment representing an image, the second data segment representing a text of the image; and
the selecting the image vector includes:
performing a matching operation between the search vector and the first data segment as well as the second data segment of the image vector respectively;
determining that the search vector matches at least one of the first data segment and the second data segment; and
determining that the search vector matches the image vector.

12. A system comprising:
one or more processors; and
one or more computer storage media storing thereon computer-readable instructions that, when executed by the one or more processors, cause the one or more processors to perform acts comprising:
receiving a query request carrying a keyword;
generating a search vector that represents the keyword; and
selecting, in a same vector space, an image vector matching the search vector to obtain a result set, the image vector represents an image and a text of the image.

13. The system of claim 12, wherein the acts further comprise:
sending the result set to a client terminal sending the query request.

14. The system of claim 12, wherein the acts further comprise:
providing an index that includes the image vector and an access identifier, the access identifier being used to access the image represented by the image vector.

15. The system of claim 12, wherein the selecting the image vector includes:
performing a matching operation between the image vector and the search vector to obtain a result set, the result set including the access identifier corresponding to the image vector matching the search vector.

16. The system of claim 12, wherein the generating the search vector includes:
performing word segmentation on the keyword to obtain at least one sub-keyword;
generating a respective term representation value according for a respective sub-keyword, the respective term representation value representing a corresponding term; and
arranging term representation values to form the search vector.

17. The system of claim 16, wherein the arranging the term representation values to form the search vector includes:
arranging the term representation values according to a sequence of the sub-keywords represented by the term representation values in the keyword.

18. The system of claim 12, wherein:
the image vector includes a first data segment and a second data segment, the first data segment representing an image, the second data segment representing a text of the image.

19. The system of claim 18, wherein the selecting the image vector includes:
performing a matching operation between the search vector and the first data segment as well as the second data segment of the image vector respectively;
determining that the search vector matches at least one of the first data segment and the second data segment; and
determining that the search vector matches the image vector.

20. One or more computer storage media storing thereon computer-readable instructions that, when executed by one or more processors, cause the one or more processors to perform acts comprising:
receiving a query request carrying a keyword;
generating a search vector that represents the keyword; and
selecting, in a same vector space, an image vector matching the search vector to obtain a result set, the image vector represents an image and a text of the image.
